(19) United States
(12) Patent Application Publication
(10) Pub. No.: US 2026/0196951 A1
(43) Pub. Date: Jul. 9, 2026

(54) DRIVING DEVICE WITH EMERGENCY HANDLING FUNCTION

(71) Applicant: HIWIN TECHNOLOGIES CORP., TAICHUNG CITY (TW)

(72) Inventor: Yen-Shun HUANG, TAICHUNG CITY (TW)

(21) Appl. No.: 19/010,364

(22) Filed: Jan. 6, 2025

(51) Int. Cl. H02P 3/06; H02H 7/08; H02P 3/02

(52) U.S. Cl. CPC H02P 3/06; H02H 7/0822; H02P 3/02

(57) ABSTRACT

A driving device with an emergency handling function includes a motor module, an emergency switch and a handling apparatus. The handling apparatus has a power supply delay time and a control delay time. When the emergency switch is triggered, the handling apparatus is triggered to perform an emergency stop flow. The emergency stop flow includes: the power supply delay time and the control delay time are counted, and in the process of counting the control delay time, a deceleration signal is output to the motor module so as to enable the motor module to drive the motor module to perform deceleration operation. Then, at the end of counting the control delay time, a turn-off signal is output so as to turn off the of motor module. At the end of counting the power supply delay time, a power supply is stopped from supplying power to the motor module.

### BACKGROUND OF THE INVENTION

### 1. Field of the Invention

The present invention relates to an emergency handling system of an electromechanical device, and in particular to a driving device with an emergency handling function.

### 2. Description of the Related Art

Motors have been popularized and applied to various production, transportation or processing environments to serve as a driving source of a device. However, it is inevitable to meet an emergency in a working environment and emergency stop is required. For example, the China invention patent of CN 116100577B discloses a torque turn-off module, a method, a safety control module and a robot. Paragraph 0037 of the specification discloses that a delay module and a time monitoring module receive a turn-off signal at the same time, the delay module delays the turn-off signal, and the delay time may be a time required for the motor to decelerate to an expected rotating speed, so that the damage to the motor caused by controlling the emergency stop of the motor can be reduced. On the other hand, when the delay module works normally, the delay module outputs the turn-off signal to an output module after a first timing duration. When the delay module works abnormally and cannot output the turn-off signal, the time monitoring module outputs the turn-off signal after a second timing duration greater than the first timing duration, the time monitoring module can output the turn-off signal to the output module when the delay module is abnormal; meanwhile, the output module outputs the turn-off signal output by the delay module or the turn-off signal output by the time monitoring module to the motor so as to control the motor to perform torque turn-off and improve the reliability of torque turn-off control.

In short, the process of controlling the motor by the delay module and the time monitoring module to turn off will not inform a controller or firmware of the motor and will not turn off the power. Although the delay time can decelerate the motor to be turned off, the controller or firmware still can give action instructions continuously without correctly remembering the current state of emergency stop. Then, taking whether the rotating speed of the motor is reduced to the expected rotating speed as a main determination basis, collision still may occur due to high rotating speed and shorter distance to an obstacle, and the effect of emergency stop cannot be achieved.

### SUMMARY OF THE INVENTION

In view of the above shortcomings, a driving device with an emergency handling function provided by the present invention can inform a control apparatus to decelerate a motor module when emergency handling is required, and then can power off to reduce the braking burden of the motor module, improve the reliability and prolong the service life of the driving device.

To achieve the above objective, a driving device with an emergency handling function provided by the present invention includes a motor module, an emergency switch and a handling apparatus. The motor module includes a power supply input terminal, a control apparatus, a driving apparatus and a motor. The control apparatus is connected to the driving apparatus to control the driving apparatus. The driving apparatus is connected to the power supply input terminal and the motor and configured to drive the motor. The handling apparatus is connected to the motor module and the emergency switch, and has a power supply delay time and a control delay time. The control delay time is shorter than the power supply delay time. When the emergency switch is triggered, the handling apparatus is triggered to perform an emergency stop flow. The emergency stop flow includes: the power supply delay time and the control delay time are counted, and in the process of counting the control delay time, a deceleration signal is output to the control apparatus, and the control apparatus controls the driving apparatus to drive the motor to perform deceleration operation. Then, at the end of counting the control delay time, a turn-off signal is output to the driving apparatus so as to turn off the driving apparatus. At the end of counting the power supply delay time, a power supply is stopped from supplying power to the power supply input terminal.

In this way, when emergency stop is required, the driving device with the emergency handling function provided by the present invention can sequentially inform the control apparatus by counting the power supply delay time and the control delay time to decelerate the motor, then stop the driving apparatus and finally turn off the power supply, thereby reducing the breaking burden of the motor module during the emergency stop, and prolonging the service life and improving the reliability of the driving device.

The detailed structure, characteristics, operation or determination mode of the driving device with the emergency handling function provided by the present invention will be described in the detailed description of the subsequent embodiments. However, those with ordinary knowledge in the field of the present invention should understand that the detailed description and the specific embodiments listed for implementing the present invention are only for describing the present invention and are not intended to limit the patent application scope of the present invention.

### BRIEF DESCRIPTION OF THE DRAWINGS

FIG. 1 is a schematic block diagram of composition of a driving device according to the present invention;

FIG. 2 is a circuit diagram of an embodiment of a handling apparatus of a driving device in FIG. 1; and

FIG. 3 is a circuit diagram of another embodiment of a handling apparatus of a driving device in FIG. 1.

### DETAILED DESCRIPTION OF THE INVENTION

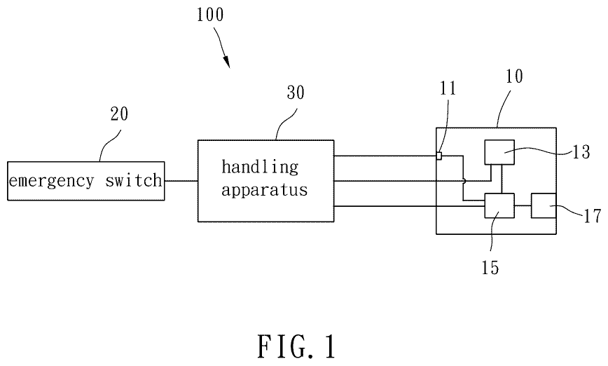

As shown in FIG. 1, a driving device 100 provided by the present invention includes a motor module 10, an emergency switch 20 and a handling apparatus 30. The driving device 100 may be applied to the application environments such as production, processing, transportation, robots and robot arms, so the driving device 100 may also be referred to as a production device, a processing device and a storage and transportation device.

The motor module 10 includes a power supply input terminal 11, a control apparatus 13, a driving apparatus 15 and a motor 17. The control apparatus 13 is connected to the driving apparatus 15 to control the driving apparatus 15. The driving apparatus 15 is connected to the power supply input terminal 11 and the motor 17 and configured to drive the motor 17.

The handling apparatus 30 is connected to the emergency switch 20, and has a power supply delay time and a control delay time. The control delay time is shorter than the power supply delay time. When the emergency switch 20 is triggered, the handling apparatus 30 is triggered to perform an emergency stop flow. The emergency stop flow includes: the power supply delay time and the control delay time are counted, and in the process of counting the control delay time, a deceleration signal is output to the control apparatus 13, and the control apparatus 13 controls the driving apparatus 15 according to the deceleration signal to drive the motor 17 to perform deceleration operation. Then, at the end of counting the control delay time, a turn-off signal is output to the driving apparatus 15 so as to turn off the driving apparatus 15. At the end of counting the power supply delay time, a power supply is stopped from supplying power to the power supply input terminal 11. In this embodiment, the power supply delay time and the control delay time are counted synchronously. In this embodiment, the motor 17 operates at a fixed rotating speed, the length of the control delay time is approximately defined by the reduction of the fixed rotating speed of the motor 17 to a stop state. In this way, the driving apparatus 15 can stop the motor 17 from operating according to the deceleration signal. However, in other embodiments, the motor 17 also can be decelerated to an extremely low rotation state according to the deceleration signal, without being limited by the stoppage and the certain rotating speed.

The driving device 100 provided by the present invention can perform the above operation after the emergency switch 20 is triggered, so that the handling apparatus performs the emergency stop flow, and the motor module 10 is segmentally (the motor 17 is decelerated, then the driving apparatus 15 is turned off and finally the power supply is turned off) controlled to stop operation, thereby avoiding system abnormality or errors caused by the failure of a single emergency stop mechanism. In the emergency stop flow, the motor 17 is decelerated, so that the burden of the breaking module of the motor 17 can be reduced, the service life can be prolonged, and the stability of the device can be improved.

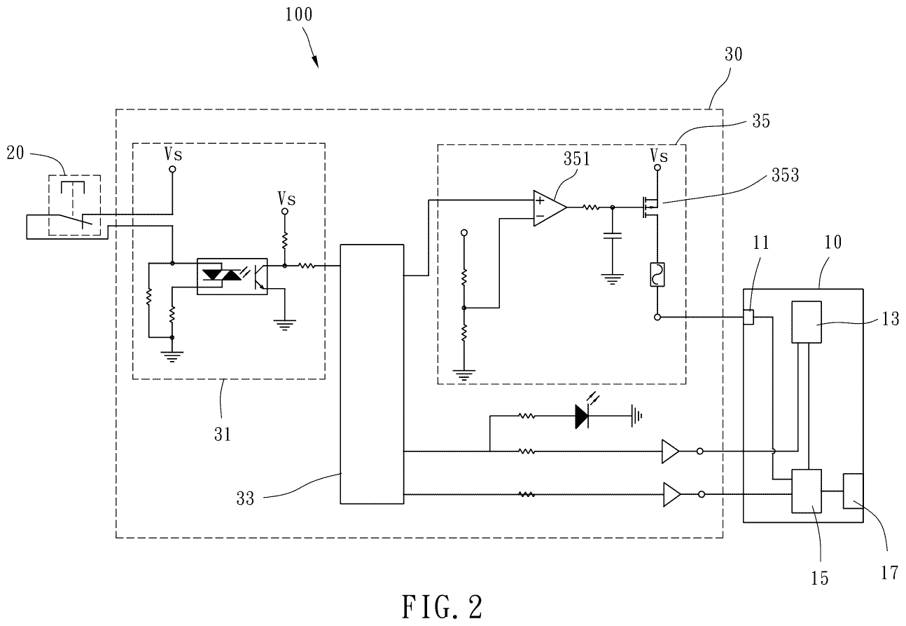

As shown in FIG. 2, the handling apparatus 30 includes an input circuit 31, a microcontroller 33 and a power supply switching circuit 35. The input circuit 31 is connected to the emergency switch 20 and the microcontroller 33. The microcontroller 33 is connected to the power supply switching circuit 35, the control apparatus 13 and the driving apparatus 15, and is configured to count the control delay time to generate corresponding deceleration signals and turn-off signals. The power supply switching circuit 35 is connected to the power supply input terminal 11.

The emergency switch 20 triggers the input circuit 31 to enable the microcontroller 33 to perform the emergency stop flow so as to perform counting and operation according to the power supply delay time and the control delay time. The power supply switching circuit 35 includes a comparator 351 and a P-channel transistor 353. A normal-phase input terminal of the comparator 351 is connected to the microcontroller 33, a reverse-phase input terminal of the comparator 351 has a reference voltage, the reference voltage is a divided voltage of a series resistor, and in other embodiments, the series resistor may be a variable resistor. A gate of the P-channel transistor 353 is connected to an output terminal of the comparator 351, a source of the P-channel transistor 353 is connected to a power supply, and a drain of the P-channel transistor 353 is connected to the power supply input terminal 11, so that the comparator 351 is triggered to change a state at the end of counting the power supply delay time, the P-channel transistor 353 is cut off (turned off), and the power supply is interrupted to supply power to the power supply input terminal 11.

The P-channel transistor 353 is regarded as an electronic switching element. In other embodiments, the P-channel transistor 353 may be a relay, a solid-state relay (SSR) or other switching elements.

In addition, after the emergency flow is finished and when the emergency switch 20 is triggered again, the microcontroller 33 of the handling apparatus 30 is triggered to perform a reset flow, the handling apparatus 30 triggers the comparator 351 to change the state, so that the P-channel transistor 35 is conducted and supplies the power to the power supply input terminal 11. The microcontroller 33 counts the control delay time, the control apparatus 13 is triggered in the counting process, and then the driving apparatus 15 is triggered at the end of counting the control delay time. In this way, the driving device provided by the present invention may be reset again to perform work.

For the process of counting the control delay time by the microcontroller 33, the control delay time in this embodiment has a control time and a driving time, the handling apparatus 30 outputs a deceleration signal after the end of counting the control time so as to trigger the control apparatus 13 to control the driving apparatus 15, and the driving time is counted. In this way, the control apparatus 13 and the firmware thereof can know that the motor 17 is required to be decelerated to stop. After the driving time is counted, the handling apparatus 30 outputs a turn-off signal to turn off the driving apparatus 15. In short, in the process of counting the driving time, the driving apparatus 15 decelerates the motor 17 to stop operation and then be turned off.

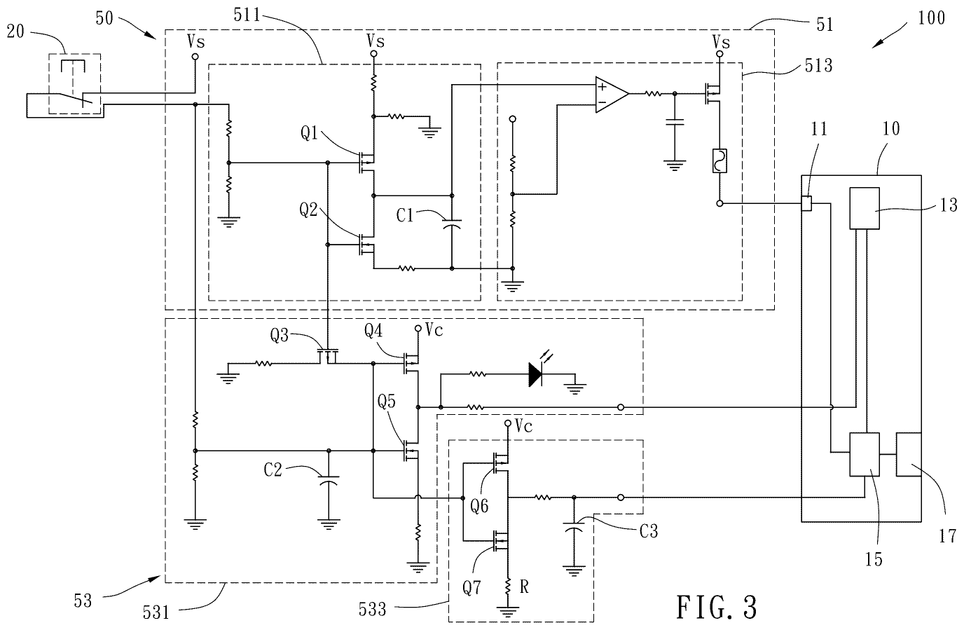

As shown in FIG. 3, compared with the embodiment in FIG. 2, in FIG. 3, the microcontroller and the input circuit are omitted, a hardware circuit including an active element and a passive element is selected. Therefore, the serial number of the handling apparatus is represented by 50. The handling apparatus 50 includes a power supply delay module 51 and a control delay module 53. The power supply delay module 51 is connected to the emergency switch 20, the control delay module 53 and the power supply input terminal 11 so as to control a power supply path of the power supply input terminal 11. The power supply delay module 51 defines the power supply delay time. The control delay module 53 is configured to trigger the control apparatus 13 to control the driving apparatus 15 in the process of counting the control delay time and turn off the control apparatus 13 and the driving apparatus 15 after the end of counting the control delay time.

The power supply delay module 51 has a power supply capacitive circuit 511 and a power supply switching circuit 513. The power supply capacitive circuit 511 is connected to the emergency switch 20 and the control delay module 53. The power supply switching circuit 513 is connected to the power supply capacitive circuit 511 and the power supply input terminal 11. The composition and operation of the power supply switching circuit 513 are the same as those of the power supply switching circuit in FIG. 2, which thus will not be elaborated. The power supply delay time is related to the charging time of the power supply capacitive circuit 511. At the end of the counting the power supply delay time, the power supply capacitive circuit 511 triggers the power supply switching circuit 513 to turn off a power supply V_{S} to the power supply input terminal 11.

In this embodiment, the power supply capacitive circuit 511 includes a first P-channel transistor Q1, a first N-channel transistor Q2 and a first capacitor C1. A gate of the first P-channel transistor Q1 is connected to the emergency switch 20, a gate of the first N-channel transistor Q2 and the control delay module 53 through the series resistor, a source of the first P-channel transistor Q1 is connected to the power supply V_{S} through the series resistor, and a drain of the first P-channel transistor Q1 is connected to a drain of the second N-channel transistor Q2, the first capacitor C1 and the normal-phase input terminal of the comparator of the power supply switching circuit 513. A source of the second N-channel transistor Q2 is connected to the first capacitor C1 and a ground terminal through the series resistor.

The control delay module 53 includes a front-end capacitive circuit 531 and a rear-end capacitive circuit 533. The front-end capacitive circuit 531 is connected to the emergency switch 20, the power supply delay module 51 and the control apparatus 13. The rear-end capacitive circuit 533 is connected to the front-end capacitive circuit 531 and the driving apparatus 15. The control time is related to the discharging time of the front-end capacitive circuit 531, the rear-end capacitive circuit 533 is triggered for charging after the front-end capacitive circuit 531 is discharged, and the driving time is related to the charging time of the rear-end capacitive circuit 533.

The front-end capacitive circuit 531 includes a third P-channel transistor Q3, a fourth P-channel transistor Q4, a fifth N-channel transistor Q5 and a second capacitor C2. The second capacitor C2 is connected to the emergency switch 20, a source of the third P-channel transistor Q3, a gate of the fourth P-channel transistor Q4 and a gate of the fifth N-channel transistor Q5 through the series resistor, a gate of the third P-channel transistor Q3 is connected to a gate of the second N-channel transistor Q2, and a drain of the third P-channel transistor Q3 is connected to the ground terminal through the resistor. A source of the fourth P-channel transistor Q4 is connected to a control power supply V_{C}, and a drain of the fourth P-channel transistor Q4 is connected to a drain of the fifth N-channel transistor Q5 and the control apparatus 13. A source of the fifth N-channel transistor Q5 is connected to the ground terminal through the resistor.

The rear-end capacitive circuit 533 includes a sixth P-channel transistor Q6, a seventh N-channel transistor Q7 and a third capacitor C3. A source of the six P-channel transistor Q6 is connected to the control power supply V_{C}, a gate of the six P-channel transistor Q6 is connected to a gate of the fifth N-channel transistor Q5 and a gate of the seventh N-channel transistor Q7, a source of the seventh N-channel transistor Q7 is connected to the ground terminal through a resistor R, and a drain of the seventh N-channel transistor Q7 and a drain of the sixth N-channel transistor Q6 are connected to the third capacitor C3 and the driving apparatus 15 through the resistor.

The second capacitor C2 is fully charged before the emergency switch 20 is triggered. When the emergency switch 20 is triggered, the first P-channel transistor Q1 is conducted to charge the first capacitor C1, and the second N-channel transistor Q2 is cut off to establish the power supply delay time; meanwhile, the second capacitor C2 performs discharging through the conducted third P-channel transistor Q3 to establish the control time, the fourth P-channel transistor Q4 is cut off, and the fifth N-channel transistor Q5 is conducted. The sixth P-channel transistor Q6 is cut off, and the seventh N-channel transistor Q7 is conducted, so the third capacitor C3 will not be charged.

Then, the second capacitor C2 is discharged, the counting of the control time ends, the fourth P-channel transistor Q4 is conducted, and the fifth N-channel transistor Q5 is cut off, thereby outputting the deceleration signal to the control apparatus 13, and enabling the control apparatus 13 and the firmware thereof to know a deceleration stop requirement. In this embodiment, the control apparatus 13 receives the deceleration signal changed from a low state to a high state, so that the driving apparatus 15 drives the motor 17 to decelerate and stop operation; meanwhile, the sixth P-channel transistor Q6 is conducted, and the seventh N-channel transistor Q7 is cut off, so that the third capacitor C3 is charged by the conducted sixth P-channel transistor Q6, and the driving time is established.

Finally, when the third capacitor C3 is fully charged and the counting of the driving time ends, the driving apparatus 15 receives the turn-off signal changed from a low state to a high state, and the driving apparatus 15 is turned off, so the motor 17 stops at a low rotating speed or in a substantially standstill state to reduce the braking burden. At this stage, the first capacitor C1 is also fully charged (representing a high voltage), the comparator of the power supply switching circuit 513 is turned to trigger a transistor (electronic switching element) to be cut off, and the power supply path is broken, so the power supply V_{S} cannot be transported to the power supply input terminal 11.

The above is the operation description of the emergency stop flow in FIG. 3. Then, the emergency switch 20 is pressed again to reset the driving device 100 so as to trigger the handling apparatus 30, thereby enabling the handling apparatus 30 to perform the reset flow. The reset flow includes: the power supply capacitive circuit 511 is discharged and the front-end capacitive circuit 531 is charged. At this time, the emergency switch 20 is changed from a low voltage to a high voltage, the second capacitor C2 is charged, the first P-channel transistor Q1 is turned off, and the first capacitor C1 is discharged through the conducted second N-channel transistor Q2.

Then, at the end of discharging the power supply capacitive circuit 511, the power supply switching circuit 513 is triggered to transport the power supply V_{S} to the power input terminal 11. The discharging of the first capacitor C1 ends (representing the low voltage), so that the normal-phase input terminal of the comparator of the power supply switching circuit 513 is changed from the high state to the low state to trigger the transistor (electronic switching element) of the power supply switching circuit 513 to be conducted, thereby supplying the power of the power supply V_{S} to the power supply input terminal 11.

When the front-end capacitive circuit 531 is fully charged, the control apparatus 13 is awakened, and the rear-end capacitive circuit 533 starts to discharge. Then, when charging of the second capacitor C2 is completed, the fifth N-channel transistor Q5 is conducted to awaken the control apparatus 13, and the third capacitor C3 performs discharging through the conductive seventh N-channel transistor Q7.

Finally, after discharging of the rear-end capacitive circuit 533 is completed (that is, discharging of the third capacitor C3 is completed), the driving apparatus 15 is awakened. In this way, the driving device 100 is reset again. The time difference between the control apparatus 13 being awakened and the driving apparatus 15 being awakened is related to the discharging time of the third capacitor C3. Therefore, when it is necessary to accelerate the time of awaking the driving apparatus 15, the resistance value of the discharging path of the third capacitor C3 can be reduced, that is, a resistor connected to the source of the seventh N-channel transistor Q7, or other resistors in the path.

What is claimed is:

1. A driving device with an emergency handling function, comprising:
a motor module, comprising a power supply input terminal, a control apparatus, a driving apparatus and a motor, the control apparatus being connected to the driving apparatus to control the driving apparatus, and the driving apparatus being connected to the power supply input terminal and the motor and configured to drive the motor;
an emergency switch; and
a handling apparatus, connected to the motor module and the emergency switch and having a power supply delay time and a control delay time, the control delay time being shorter than the power supply delay time, wherein when the emergency switch is triggered, the handling apparatus is triggered to perform an emergency stop flow, and the emergency stop flow comprises: the power supply delay time and the control delay time are counted, a deceleration signal is output to the control apparatus in the process of counting the control delay time, the control apparatus controls the driving apparatus to enable the motor to perform deceleration operation, then at the end of counting the control delay time, a turn-off signal is output to the driving apparatus so as to turn off the driving apparatus, and at the end of counting the power supply delay time, a power supply is stopped from supplying power to the power supply input terminal.

2. The driving device with the emergency handling function according to claim 1, wherein the control delay time has a control time and a driving time, at the end of counting the control time, the handling apparatus outputs the deceleration signal and starts to count the driving time, and the handling apparatus outputs the turn-off signal after counting of the driving time is completed.

3. The driving device with the emergency handling function according to claim 2, wherein the handling apparatus comprises a power supply delay module and a control delay module, the power delay module is connected to the emergency switch, the control delay module and the power supply input terminal so as to control a power supply path of the power supply input terminal, the power supply delay module defines the power supply delay time and configured to control the power supply to supply power to the power supply input terminal, the control delay module is connected to the control apparatus and the driving apparatus, the control delay module defines the control delay time, and the control delay module is configured to generate the deceleration signal in the process of counting the control delay time and generate the turn-off signal at the end of counting the control delay time.

4. The driving device with the emergency handling function according to claim 3, wherein the control delay module comprises a front-end capacitor circuit and a rear-end capacitive circuit, the front-end capacitor circuit is connected to the emergency switch, the power supply delay module and the control apparatus, the rear-end capacitive circuit is connected to the front-end capacitive circuit and the driving apparatus, the control time is related to the discharging time of the front-end capacitive circuit, the rear-end capacitive circuit is triggered to charge after discharging of the front-end capacitive circuit is completed, and the driving time is related to the charging time of the rear-end capacitive circuit.

5. The driving device with the emergency handling function according to claim 4, wherein the power supply delay module has a power supply capacitive circuit and a power supply switching circuit, the power supply capacitive circuit is connected to the emergency switch and the control delay module, the power supply switching circuit is connected to the power supply capacitive circuit and the power supply input terminal, the power supply delay time is related to the charging time of the power supply capacitive circuit, and when the power supply delay time expires, the power supply capacitive circuit triggers the power supply switching circuit to turn off the power supply to the power supply input terminal.

6. The driving device with the emergency handling function according to claim 5, wherein after the emergency stop flow is finished, the emergency switch triggers the handling apparatus again to enable the handling apparatus to perform a reset flow; and the reset flow comprises:
the power supply capacitive circuit performs discharging and the front-end capacitive circuit is charged, the power supply switching circuit is triggered to transport the power supply to the power supply input terminal when discharging of the power supply capacitive circuit is finished, then when the front-end capacitive circuit is fully charged, the control apparatus is awakened, the rear-end capacitive circuit starts to discharge, and the driving apparatus is awakened after discharging of the rear-end capacitive circuit is finished.

7. The driving device with the emergency handling function according to claim 6, wherein the power supply switching circuit comprises a comparator and an electronic switching element, the comparator is connected to the power supply capacitive circuit and the electronic switching element, the electronic switching element is connected to the power supply and the power supply input terminal, and the comparator triggers the electronic switching element according to a voltage state of the power supply capacitive circuit.

8. The driving device with the emergency handling function according to claim 6, wherein the time difference between the control apparatus being awakened and the driving apparatus being awakened is related to the discharging time of the rear-end capacitive circuit.

9. The driving device with the emergency handling function according to claim 1, wherein the power supply delay time and the control time are counted synchronously.

10. The driving device with the emergency handling function according to claim 1, wherein the driving apparatus enables the motor to stop operation according to the deceleration signal.
